(19) United States
(12) Patent Application Publication
(10) Pub. No.: US 2022/0298426 A1
(43) Pub. Date: Sep. 22, 2022

(54) RISER REACTOR SYSTEM

(71) Applicant: SHELL OIL COMPANY, HOUSTON, TX (US)

(72) Inventors: Zhe CUI, Houston, TX (US); Robert Alexander LUDOLPH, Houston, TX (US)

(21) Appl. No.: 17/625,826

(22) PCT Filed: Jul. 27, 2020
(86) PCT No.: PCT/EP2020/071116

§ 371 Date: Jan. 10, 2022

Related U.S. Application Data
(60) Provisional application No. 62/880,345, filed on Jul. 30, 2019.

(51) Int. Cl. C10G 11/18; B01J 8/00; B01J 8/32; B01J 8/38

(52) U.S. Cl. CPC C10G 11/18; C10G 11/187; B01J 8/0015; B01J 8/32; B01J 8/388; C10G 2300/4006; B01J 2208/00769; C10G 2300/70; B01J 2208/0053; B01J 2208/00654

(57) ABSTRACT

A reactor and a process for fluid catalytic cracking (FCC) a hydrocarbon feed in the riser-reactor, the process including injecting the hydrocarbon feed into an evaporation zone of the riser-reactor, injecting a first catalyst into the evaporation zone, wherein the first catalyst mixes with the hydrocarbon feed to generate a hydrocarbons stream in the evaporation zone, and wherein the temperature in the evaporation zone is less than 625° C., and passing the hydrocarbons stream from the evaporation zone into a cracking zone of the riser-reactor to generate a cracked product in the cracking zone.

### FIELD OF INVENTION

The present invention relates to an apparatus and method for fluidized catalytic cracking (FCC) a hydrocarbon feed. More particularly, it relates to an apparatus and method for containing feed vaporization and feed-catalyst (i.e., hydrocarbons) mixing to a zone designated for such in an FCC riser-reactor and for injecting feed/catalyst into the FCC riser-reactor at multiple injection points in an effort to decrease thermal cracking and dry gas production during vaporization of the feed and to improve feed/catalyst mixing.

### BACKGROUND

The process of fluidized catalytic cracking (FCC) is an important conversion process often carried out in modern-day oil refineries. The FCC process is a chemical process that uses catalyst to convert high-boiling hydrocarbon fractions derived from crude oils into more valuable FCC end products, such as gasoline components (naphtha), fuel oils, and olefinic gases (i.e., ethene, propene, butene). A typical FCC unit includes at least one of each, including, an FCC reactor (i.e., riser-reactor), a regenerator, and a separator. The riser-reactor and regenerator are considered to be the main components of the FCC unit. For instance, a majority of the endothermic cracking reactions of hydrocarbon feed and coke deposition take place in the riser-reactor whereas the regenerator is utilized to reactivate the catalyst by burning off accumulated coke deposit.

During FCC operations, heated catalyst flows from the regenerator and into a bottom section of the riser-reactor where it contacts a heated hydrocarbon feed. Upon contact, the catalyst vaporizes and cracks, or breaks, the long-chain molecules of the feed into new, shorter molecules whereby a feed-catalyst mixture is formed. The vaporized feed fluidizes the solid catalyst so that the feed-catalyst mixture expands and flows upwardly within the riser-reactor to be further cracked, thereby, yielding one or more desirable cracked products. Additionally, coke formation begins to deposit on the catalyst during the reactions, thus, causing the catalyst to gradually deactivate.

Desirable cracked products are drawn off the top of the riser-reactor to flow into a bottom section of a separator and deactivated catalyst is drawn off the bottom of the riser-reactor to flow into the regenerator. The cracked products that flow into the separator, also referred to as a main fractionator, are distilled into the more valuable FCC end products. The regenerated, i.e., reactivated, catalyst that exits the regenerator is recirculated to the bottom section of the riser-reactor, and the cycle repeats. In many instances, fresh catalyst may be added with the regenerated catalyst to optimize the cracking process.

Although the FCC process has been commercially established for over 75 years, technological advances are continually evolving to meet new challenges and to provide overall continuous improvement. For instance, competitors in the market have introduced various processes, techniques, and equipment related to the FCC riser-reactor such as design changes to feed injection nozzles in an effort to improve feed and/or catalyst distribution and feed/catalyst mixing, the creation of multiple catalyst injection points to increase product yields and selectivity of the cracking reactions, and the redesign of the reaction system to eliminate or decrease non-selective thermal cracking and dry gas production. Several of these developments are discussed as follows.

U.S. Pat. Nos. 4,795,547 and 5,562,818 describe two bottom entry nozzles with different diverter cones designs at the exit of a feed pipe carrying atomized feed. The function of these diverter cones is to redirect the axially flowing feed stream to a radially discharging feed at the exit in an effort to enhance regenerated catalyst and feed mixing.

U.S. Pat. No. 5,565,090 describes a riser reactor with multiple catalyst injection points to obtain aromatics yields from a naphtha feedstock during a catalytic reforming process. The catalyst joins the feedstock at the base of a riser reactor and is injected into the resulting mixture of feedstock, reactants, and catalyst at an intermediate point along the length of the riser. Preferably 2-10 catalyst injection points are supplied, including one at the base of the riser and 1-9 intermediate points. About 10 to 95% of the catalyst joins the feedstock in the lower end of the riser reactor and about 1 to 70% of the catalyst is injected at any single other point along the length of the riser.

U.S. Pat. No. 5,055,177 describes a method and apparatus for separating a catalyst phase from a gas suspension phase, as the gas suspension phase is discharged from a riser conversion zone outlet to rapidly separate cracking catalyst from a hydrocarbon vapor/catalyst particle suspension in an FCC process. In particular, the hydrocarbon vapor/catalyst particle suspension passes directly from a riser into a series of cyclonic separators, which separate the catalyst particles from the suspension, in an effort to reduce over-cracking of hydrocarbon conversion products and promote the recovery of desired products. The cyclonic separators connected in series within a single reactor vessel include a riser cyclone separator, a primary cyclone separator, and a secondary cyclone separator.

Despite the various attempts, enhanced FCC processes, components, and techniques are still needed for continual advancements, including improvements related to temperature and velocity profiles across the riser-reactor, uniformity during feed-catalyst mixing, and performance during catalytic reactions, among other desired improvements.

### SUMMARY OF THE INVENTION

It is an objective of this invention to provide an apparatus and method for fluid catalytic cracking (FCC) a hydrocarbon feed.

It is an objective of this invention to provide an apparatus and method for containing feed vaporization and feed/catalyst mixing to a zone designated for such in a FCC riser-reactor and for injecting feed and catalyst at multiple injection points in the FCC riser-reactor in an effort to decrease thermal cracking and dry gas production during vaporization of the feed and to improve feed/catalyst mixing.

It is an objective of this invention to provide an apparatus and method thereof where feed vaporization and feed-catalyst mixing are designated to a specific zone in an FCC riser-reactor.

It is an objective of this invention to provide an apparatus and method thereof where feed vaporization and feed-catalyst mixing are designated to a specific zone in an FCC riser-reactor and where catalyst is injected at multiple injection points along the length of the FCC riser-reactor.

Other advantages and features of embodiments of the present invention will become apparent from the following detailed description. It should be understood, however, that the detailed description, while indicating preferred embodiments of the invention, is given by way of illustration only, since various changes and modifications within the spirit and scope of the invention will become apparent to those skilled in the art from this detailed description.

### DESCRIPTION OF THE DRAWINGS

Certain exemplary embodiments are described in the following detailed description and in reference to the drawings, in which:

FIG. 1 is a schematic representation of an FCC unit, including a riser-reactor system with multi-stage catalyst injection, in accordance with the embodiments of the present invention;

FIG. 2 is a schematic representation of the riser-reactor system with multi-stage catalyst injection as shown in FIG. 1, in accordance with the embodiments of the present invention;

FIG. 3 is a schematic representation of a second stage injection device for the riser-reactor system with multi-stage catalyst injection as shown in FIG. 2, according to a first embodiment of the invention;

FIG. 4 is a schematic representation of a second stage injection device for the riser-reactor system with multi-stage catalyst injection as shown in FIG. 2, according to a second embodiment of the invention;

FIG. 5 is a graphical comparison of a temperature profile for a conventional riser-reactor as compared to a temperature profile for the riser-reactor system with multi-stage catalyst injection as shown in FIG. 2, in accordance with the embodiments of the present invention;

FIG. 6 is a graphical comparison of radial distribution profiles of axial velocities for a conventional riser-reactor as compared to radial distribution profiles of axial velocities for the riser-reactor system with multi-stage catalyst injection as shown in FIG. 2, in accordance with the embodiments of the present invention.

### DETAILED DESCRIPTION

A majority of the endothermic cracking reactions during an FCC process take place in an FCC riser-reactor, which may be comprised of one or more reaction zones. In conventional FCC riser-reactors, both vaporization of the feed and cracking reactions can occur in the same reaction zone of the reactor, usually, at elevated temperatures, e.g., at least 630° C. In other typical FCC riser-reactors, several riser-reactors may be used in series where each riser-reactor includes at least one reaction zone operating within an elevated temperature range to sequentially vaporize and crack the feed.

A substantial majority, preferably all, feed should be vaporized and uniformly mixed with catalyst before initiating cracking of the vaporized feed in order to produce maximum yields of desirable end products. If not, incomplete vaporization of the feed may lead to the formation of undesirable by-products, such as coke due to oil-to-oil contacting. Elevated temperatures, as previously described with respect to conventional riser-reactors, can also promote pre-mature thermal cracking of the vaporized feed. Undesirable thermal cracking can lead to the generation of unwanted dry gas, thus, affecting the production yields of more valuable products, such as light olefins.

During a thermal cracking process, elevated temperatures and pressures are used to crack a feed without the use of catalysts. Conversely, in the FCC process, vaporized feed is cracked upon contact with a hot catalyst at lower temperatures and pressures as compared to thermal cracking conditions. Regardless of whether a catalyst is used to initiate cracking reactions, elevated reaction temperatures in the riser-reactor, such as greater than about 630° C., encourage pre-mature thermal cracking of the feed. In this regard, increased temperatures across the riser-reactor decrease high-value product yields while increasing low-value products such as heavy fuel oil and light gases (e.g., methane and ethane).

It has now been advantageously found that the described problems caused by thermal cracking, dry gas production, and lack of uniform feed/catalyst mixing, among others, may be overcome by the present invention, which relates to an inventive riser-reactor for use during an FCC process and an FCC process for catalytically cracking a hydrocarbon feed in the inventive riser reactor. The riser-reactor of the present embodiments includes separate, and distinctive zones including an evaporation zone and a cracking zone. A substantial majority, preferably essentially all, feed/catalyst mixing and feed vaporization are confined to the evaporation zone of the present riser-reactor embodiments where the temperature within the evaporation zone is less than 625° C., preferably less than 550° C., more preferably less than 525° C. Since minimal cracking occurs in the evaporation zone, a substantial majority of the vaporized feed is cracked in the cracking zone of the present riser-reactor embodiments. It has been surprisingly found that the inventive riser-reactor with an evaporation zone configured for feed vaporization and for containing a feed/catalyst mixture, reduces the occurrence of thermal cracking before catalytic cracking of the feed begins, since temperatures in the evaporation zone are less than 625° C., preferably less than 550° C., more preferably less than 525° C. With the reduction in thermal cracking, other advantages as provided by the inventive embodiments includes a reduction in dry gas production (e.g., methane, ethane) and an increase in FCC unit capacity since various FCC equipment, such as the wet gas compressor, is not overloaded with excessive dry gas, thereby, providing higher product yields.

With typical FCC units, the majority of catalyst is injected into a bottom section of the riser-reactor so that catalyst concentration is higher than feed concentration in that particular section. Yet, when catalyst injection takes place on one side of the riser-reactor, the localized catalyst concentration will be higher along that one side than the cross-sectional average catalyst concentration of the riser-reactor. This occurrence may lead to nonuniformity of catalyst distribution within the riser-reactor. However, the present embodiments include at least two catalyst injection points along the length of the riser-reactor, including at least one catalyst injection point in the evaporation zone and at least one catalyst injection point in the cracking zone, so that the catalyst concentration is more evenly distributed. In this regard, the majority of catalyst concentration that would have been injected into the bottom section during conventional operations is now injected into both the evaporation zone (i.e., first stage catalyst injection) and the cracking zone (i.e., second stage catalyst injection). Therefore, with the present embodiments, there is now is a lower catalyst concentration, or a diluted catalyst concentration, in the evaporation zone which is located at the bottom section of the riser-reactor. A beneficial advantage of multiple catalyst injection points includes more complete and uniform feed/catalyst mixing along the entire length of the riser-reactor. It should be noted that in other embodiments of the present invention additional stages of catalyst injection (e.g., third and/or fourth stage catalyst injection) may be implemented. In addition to reduced thermal cracking/dry gas production and more uniform feed/catalyst mixing, the synergistic behavior exhibited by the combination of lower temperatures in the evaporation zone and multi-catalyst injection also includes ideal plug-flow conditions and more uniform radial gas/solid velocity profiles throughout the riser-reactor. In this regard, the beneficial effects of the inventive riser-reactor promote increased catalyst selectivity/activity during cracking reactions and increased product yields.

Moreover, the synergy displayed by the inventive riser-reactor results in several other benefits and advantages. Since temperatures are lower in the evaporation zone as compared to typical FCC riser-reactors, the inventive riser-reactor demonstrates an overall lower and more uniform temperature profile across the entire length of the reactor, thus, a higher riser-reactor temperature profile (e.g., at least 700° C.) is avoided. The overall lower temperatures of the riser-reactor embodiments beneficially provide more flexibility regarding the types of materials utilized within the FCC unit, including the use of materials susceptible to higher temperatures. Moreover, with separate evaporation and cracking zones, the present invention provides the unexpected advantage of avoiding increased equipment costs and operational complexity, for example, when additional equipment such as several riser-reactors in series are implemented.

Modern FCC units can process a wide variety of feedstocks and catalysts and can be configured to adjust operating conditions for maximize production of valuable FCC end products such as gasoline, middle distillate, or light olefins to meet different market demands. The feed described with respect to the present embodiments can include a variety of feedstocks well known to those skilled in the art, such as, heavy gas oils (HGO), vacuum gas oils (VGO), residue feedstocks that would otherwise be blended into residual fuel oil, atmospheric gas oils (AGO), crude distillates, process intermediates, and product recycles. However, for purposes of the present embodiments, feed types and feed injection methods are subject to conventional standards and techniques, and thus, are not of discussion herein. The catalyst used for catalytic cracking and circulated within the present inventive embodiments can be any suitable catalyst known in the art to have cracking activity under suitable catalytic cracking conditions. For example, preferred cracking catalysts for use in the present embodiments may include conventional regenerated and/or fresh cracking catalysts comprised of a molecular sieve having cracking activity dispersed in a porous, inorganic refractory oxide matrix or binder, as well as shape selective cracking additives such as ZSM-5, and other cracking enhancing additives designed to selectively crack specific boiling range feed components. Nevertheless, for purposes of the present embodiments, the type of catalyst used and catalytic cracking conditions in the present invention are subject to conventional standards and techniques, and thus, are not of discussion herein.

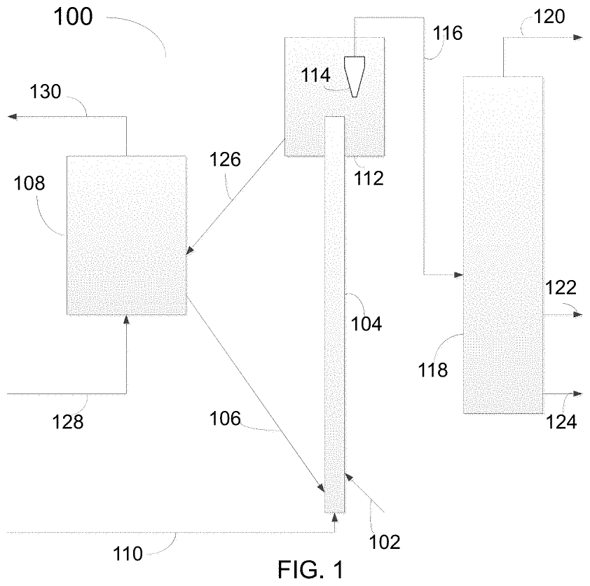

FIG. 1 is a schematic representation of an FCC unit 100, including a riser-reactor system with multi-stage catalyst injection, in accordance with the embodiments of the present invention.

As shown in FIG. 1, a hydrocarbon feed (herein referred to as “feed”) via line 102 is introduced into a bottom section of riser-reactor 104. The riser-reactor 104 may be a reaction vessel suitable for catalytic cracking reactions as known in the art and may be configured as an internal riser-reactor or an external riser-reactor. A hot regenerated catalyst (herein referred to as “catalyst”) via line 106 flows from a regenerator 108 and into the bottom of riser-reactor 104 to mix and react with the feed to form a feed-catalyst mixture. Specifically, the feed vaporizes upon contact with the hot catalyst within the bottom of riser-reactor 104. As feed vapors flow upwards along the height of the riser-reactor 104, the catalyst is fluidized and transported by the vapors so that the feed-catalyst mixture is formed. Optionally, but preferably, lift gas via line 110 can be introduced into the bottom of the riser-reactor 104 to further fluidize the catalyst and to promote proper feed-catalyst mixing.

The feed-catalyst mixture is subjected to elevated temperatures during its upward passage within the riser reactor 104. Such elevated temperatures are sufficient to break, or crack, the long-chain molecules of the feed vapors into new, shorter molecules to produce one or more cracked products while coke is simultaneously deposited on the catalyst, i.e., spent catalyst. The mixture of cracked product(s) and spent catalyst exits a top section of the riser reactor 104 and flows into a reactor vessel 112 comprising at least one separator 114. The separator 114 can be any conventional system that defines a separation zone or stripping zone, or both, and provides a means for separating the cracked product(s) from the spent catalyst. The separated cracked product(s) passes via line 116 from the separator 114 to a main fractionator system 118 that can include any system known to those skilled in the art for recovering and separating the cracked product(s) into various end product(s). The end product(s) exiting the main fractionator system 118 can include, for example, olefins (e.g., C2-C4 olefin), gasoline, middle distillate, that pass from the system 118 through lines 120, 122, 124, respectively, for continued use.

The separated spent catalyst passes from the separator 114 and into the regenerator 108 via line 126. The regenerator 108 defines a regeneration zone and provides means for contacting the spent catalyst with an oxygen-containing gas, such as air, under carbon burning conditions to remove the coke deposits. The oxygen-containing gas is introduced into the regenerator 108 via line 128 and combustion gases pass from the regenerator 108 via line 130. Regenerated catalyst flows from the regenerator 108 via line 106 and into the riser-reactor 104 to repeat the operational cycle.

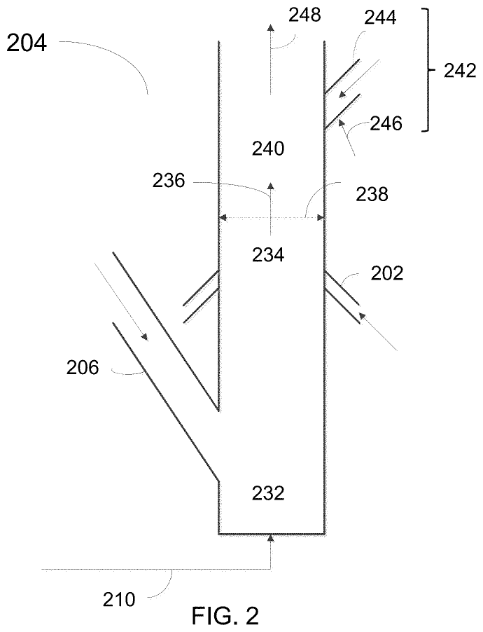

FIG. 2 is a schematic representation of the riser-reactor system with multi-stage catalyst injection as shown in FIG. 1, in accordance with the embodiments of the present invention. Like numbers are described with respect to FIG. 1. The riser reactor 204 may be any type or riser reactor including, for example, an internal or external riser-reactor and/or a riser-reactor including a lift pot 232 located at a lower end of the riser-reactor 204, as shown in FIG. 2. A first catalyst stream via distributor inlet 206 is introduced into the lift pot 232 where a lift gas via line 210 is also injected into the lift pot 232. A sufficient amount of lift gas is provided to circulate and lift the catalyst particles in an upward direction so that the particles flow into an evaporation zone 234 of the riser-reactor 204. Examples of lift gas include steam, light hydrocarbon gases, vaporized oil and/or oil fractions, and/or any mixtures of these. Steam is most preferred as a lift gas from a practical perspective. Light hydrocarbon gases may include, for example, hydrogen, methane, ethane, ethylene and/or mixtures thereof. However, the use of a vaporized oil and/or oil fractions (preferably vaporized liquefied petroleum gas, gasoline, diesel, kerosene or naphtha) as a lift gas may advantageously and simultaneously act as a hydrogen donor and may prevent or reduce coke formation. In a preferred embodiment, both steam as well as vaporized oil and/or vaporized oil fraction, light hydrocarbon gases, and/or mixtures thereof may be used as the lift gas. The lift gas can be introduced as a single stream or as multiple streams where each stream may be the same source or different sources. For example, one stream may be steam and another stream may be a vaporized oil and/or oil fraction, light hydrocarbon gases, and/or mixtures thereof.

During upward passage of the hot catalyst particles into the evaporation zone 234, a first feed via distributor inlet 202 is also introduced into zone 234 where heat from the catalyst particles vaporizes the feed. In typical processes, the first feed is pre-heated before being injected into evaporation zone 234 and the lift gas may be used to also assist with feed vaporization. Furthermore, various techniques as known in the art may be implemented during feed injection so as to enhance feed atomization and feed/catalyst contact and mixing. As the vaporized feed and catalyst particles mix, a first feed/catalyst mixture (hereafter referred to as “hydrocarbons”) 236 is formed in the evaporation zone 234. In the present embodiments, the evaporation zone 234 extends substantially across an entire diameter (as depicted by dotted line 238) of the riser-reactor 204. Therefore, feed vaporization and feed/catalyst mixing occur substantially, and most preferably entirely, within the evaporation zone 234 and across the entire diameter 238 of the riser-reactor 204. By extending the evaporation zone 234 substantially across the entire diameter 238 of the riser-reactor 204, the temperature profiles of zone 234 and of the entire riser-reactor 204 are uniformly maintained. This uniformly, maintained temperature profile avoids excessively over-cracking valuable products into less valuable products in the rise-reactor 204 and minimizes thermal cracking, which can produce undesirable by-products, e.g., dry gas and coke.

As previously stated, catalyst temperature affects both the feed vaporization rate and the likelihood of untimely feed cracking in the evaporation zone 234. Advantageously, the temperature of the first catalyst within the evaporation zone 234 is sufficient to both completely vaporize the first feed yet substantially hinder thermal cracking of the hydrocarbons 236 that are exiting the evaporation zone 234 and entering into a cracking zone 240 of the riser-reactor 204. In particular and in accordance with the invention, catalytic cracking and thermal cracking of the hydrocarbons 236 exiting the evaporation zone 234 is substantially reduced to minimal levels, more preferably to essentially no thermal cracking, in the evaporation zone 234 since zone temperatures are maintained at less than 625° C., preferably less than 550° C., and most preferably less than 525° C.

According to the various embodiments, operational variables can be monitored in an effort to influence the temperature of the evaporation zone 234, thus, ensuring complete vaporization of the first feed and minimal thermal cracking within zone 234. Examples of monitored operational variables include temperature, feed flow rate, and catalyst circulation rate, among others. Based on such variable readings, the amount of first catalyst stream injected via distributor inlet 206 into the evaporation zone 234 can be adjusted so that the first catalyst provides sufficient heat to completely vaporization but not overheat the first feed, thus, reducing and/or eliminating feed thermal cracking in the evaporation zone 234. In the embodiments, the temperature range of the evaporation zone 234 is maintained at less than 625° C., preferably less than 550° C., and most preferably less than 525° C. The amount of first catalyst stream injected via distributor inlet 206 into the evaporation zone 234 ranges from about 10% to 90% of total catalyst injection, more preferably from about 30% to 60%, most preferably from 45% to 55%; while the ratio of total catalyst stream to the feed preferably lies in the range from 1:1 to 30:1, more preferably from 3:1 to 15:1 and most preferably from 5:1 to 10:1. By injecting an amount of catalyst sufficient to maintain a temperature range that only vaporizes but does not substantially crack the first mixture, the temperature in the evaporation zone 234 of the present riser-reactor 204 is lower than the temperature used to vaporize the feed in conventional FCC riser-reactors.

Although not of subject in the present embodiments, each of the monitored operational variables can be computer controlled by process control systems as commonly used in the art. For example, the variables can be remotely monitored whereby automatic adjustments are implemented based on variable outputs, thus, reducing the need for manual changes and adjustments. It should be noted that variables related to regulating the temperature of the evaporation zone 234, other than the aforementioned, may be monitored.

Increased velocity flow due to vaporized feed production acts as the means to carry the hydrocarbons 236 further up into the riser-reactor 204 so that the hydrocarbons passes from the evaporation zone 234 and into the cracking zone 240. The cracking zone 240 is located above the evaporation zone 234 and extends substantially across the entire diameter 238 of the riser-reactor 204. The size, including length and diameter, of the evaporation zone 234, cracking zone 240, and the riser-reactor 204 of the embodiments may vary depending on the operational parameters and level of desired hydrocarbon feed conversion and production capacity, among other variables.

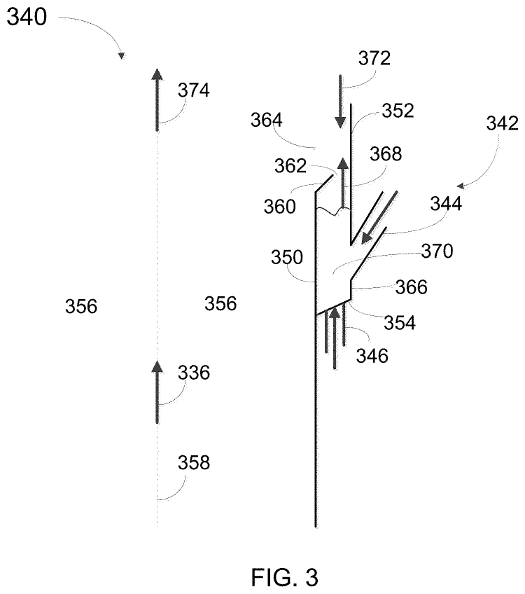

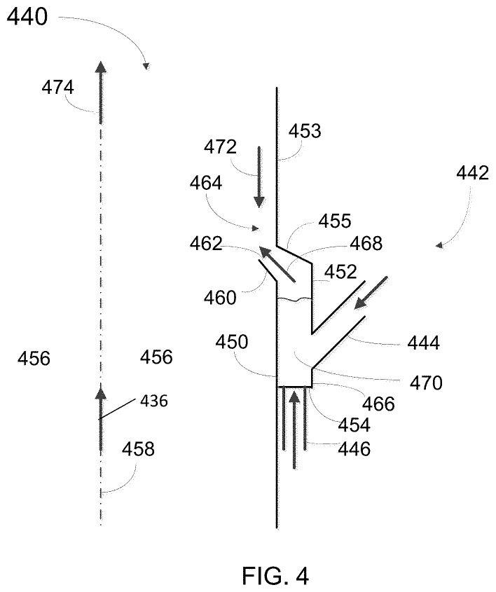

Since the temperature of the hydrocarbons 236 that leave the evaporation zone 234 to flow into the cracking zone 240 is below thermal cracking temperatures, minimal catalyst deactivation by reaction coke deposition occurs in zone 234. Accordingly, a substantial majority of catalyst in the hydrocarbons 236 that flows into the cracking zone 240 is available to catalyze the cracking reactions. Further, since feed cracking of the hydrocarbons 236 is substantially reduced to minimal levels in the evaporation zone 234, the hydrocarbons 236 can be considered as being partially cracked upon flowing into the cracking zone 240. In addition to the first catalyst stream via distributor inlet 206, the riser-reactor 204 of FIG. 2 further comprises a second stage injection device 242 which is further discussed with respect to FIGS. 3 and 4. The second stage injection device 242 of the present embodiments is configured to feed a second catalyst stream via distributor inlet 244 and a second feed stream via distributor inlet 246 into the cracking zone 240. In preferred embodiments, the ratio of first catalyst to second catalyst in the riser reactor 204 can range from about 1:9 to about 9:1 so as to minimize thermal cracking of the hydrocarbons 236 in the evaporation zone 234 and to maximum cracking of the hydrocarbons 236 when subjected to cracking temperatures in the cracking zone 240.

The second feed flows into the device 242 to mix with the second catalyst, thus, forming a second feed/catalyst mixture (not shown). Preferably, and as will be further discussed, the second feed/catalyst mixture is injected into a wall region (not shown) of the riser-reactor 204 to further flow into the cracking zone 240. Upon entering the zone 240, the second feed/catalyst mixture contacts and mixes with the rising hydrocarbons 236 exiting the evaporation zone 234 to enter the cracking zone 240. The elevated temperatures of the second feed/catalyst mixture causes further cracking of the hydrocarbons 236 so that a final crack product 248 is produced to exit a top section of the riser-reactor 204. As will be further discussed, the injection of the second catalyst in the present embodiments provides several benefits including minimizing catalyst back-mixing in the wall region, promoting improved uniformity during feed/catalyst mixing, and improving the radial velocity distribution of cracked products in the riser-reactor 204.

FIG. 3 is a schematic representation of a second stage injection device for the riser-reactor system with multi-stage catalyst injection as shown in FIG. 2, according to a first embodiment of the invention. Like numbers are described with respect to FIGS. 1 and 2. A second stage injection device 342 provides for injection of a second catalyst stream via distributor inlet 344 and a second feed stream via distributor inlet 346 into a cracking zone 340 of a riser-reactor. The device 342 includes an inner wall 350, an outer wall 352, and a base 354. In accordance with the invention, the outer wall 352 extends vertically above the inner wall 350 and includes the distributor inlet 344 for receiving the second catalyst stream.

Half of a longitudinal cross-section within an internal region 356 of cracking zone 340 is shown in FIG. 3 where a center vertical axis 358 of the riser-reactor's geometry is represented by a dotted-line. A top section of the inner wall 350 includes an inclining upward slope 360 orientated in a direction away from the center vertical axis 358, thereby, forming opening 362 located between the outer wall 352 and the slope 360 and configured to be fluidly connected to the internal region 356. The inclining upward slope 360 may prevent the ingress of fluid backflow, for example, preventing hydrocarbons 336 that are flowing upwardly along the center vertical axis 358 from flowing into a wall region 364 and/or into the second device 342.

The base 354 of the device 342 includes at least one base opening (not shown) for receiving the second feed stream. The second feed stream flows into a lower section 366 of the device 342 and, upon contact, is vaporized by the hot second catalyst stream. The contacting and mixing of the second feed and the second catalyst streams form a second feed/catalyst mixture, hereafter referred to as “fluidized ring mixture 368”, within a cavity 370 of the device 342. The catalyst particles within the fluidized ring mixture 368 are fluidized by the vaporized feed so that the mixture 368 rises upwardly to be injected through the opening 362 and into the wall region 364. In preferred embodiments, the base 354 can additionally be used for receiving a lift gas in an effort to maintain fluidization of the fluidized ring mixture 368. In other embodiments, the base 354 may include separate base openings to accommodate the second feed stream and the lift gas.

As it moves upwardly along the center vertical axis 358, the flow of the hydrocarbons 336 can be described as a core-annulus pattern where a concentration of densely aggregated catalyst particles (i.e., dense catalyst layer 372) flow downwardly within the wall region 364 while a concentration of less densely aggregated catalyst particles (i.e., central catalyst 374) continue to flow upwardly along the center vertical axis 358. The formation of the dense catalyst layer 372 within the wall region 364 often leads to non-uniform distribution of catalyst particles and non-uniform feed/catalyst mixing throughout the cracking zone 340, as well, as non-uniform gas/solid velocity distribution profiles. Moreover, the dense catalyst layer 372 flowing downwardly along the wall region 364, or the periphery of the cracking zone 340, can increase the chance for back-mixing of solid catalyst particles. In the present invention, back-mixing is undesirable since it would result in the recycling of catalyst that has already passed through part of the cracking zone 340 by flowing downwardly within the dense catalyst layer 372 with the unrecycled catalyst particles flowing upwardly within the fluidized ring mixture 368. The occurrence of back-mixing often leads to sub-optimal feed/catalyst contact, resulting in undesirable cracking reactions thereby decreasing the yield of valuable products.

However, in the present embodiments, the upward flow of the fluidized ring mixture 368 into the wall region 364 acts to deflect the downward flow of dense catalyst particles 372. Thus, by forcing the dense catalyst particles 372 back into the internal region 356, improved feed/catalyst contact and improved catalyst distribution are achieved, along with minimal to no back-mixing. It should be noted, in the embodiments, that the wall region 364 can be understood to include the area in the cracking zone 340 where the upward-flowing fluidized ring mixture 368 deflects the downward-flowing dense catalyst layer 372.

With such improvements, the present embodiments thereby advantageously promote desirable plug-flow conditions since minimized catalyst back-mixing occurs, thereby, reducing undesirable cracking reactions so as to increase the yield of desired products. Moreover, ideal plug flow conditions reduce the occurrence of side and incomplete catalytic reactions and thus, also increases the yield of desired products. Additionally, due to desirable plug-flow conditions, the velocity flow rates through the inventive riser-reactor are assumed to be more constant and uniform, as compared to typical velocity profiles in conventional riser-reactors. Thus, the present riser-reactor embodiment also provides improved overall radial gas and solid velocity profiles, as measured along the length of the riser-reactor. FIG. 4 is a schematic representation of a second stage injection device for the riser-reactor system with multi-stage catalyst injection as shown in FIG. 2, according to a second embodiment of the invention. Like numbers are described with respect to FIGS. 1-3. Half of a longitudinal cross-section through an internal region 456 of cracking zone 440 is shown in FIG. 4 where a center vertical axis 458 of the riser-reactor's geometry is represented by a dotted-line. A second stage injection device 442 is located in the cracking zone 440 and provides for a second stage injection of a second catalyst stream via distributor inlet 444 and a second feed stream via distributor line 446. The second stage injection device 442 includes an inner wall 450, an outer wall, and a base 454. In accordance with the embodiment, a top section of the inner wall 450 includes an inclining upward slope 460 orientated in a direction towards the internal region 456. The outer wall, as shown in FIG. 4, includes a first vertical section 452, a second vertical section 453, and an inclining slope 455 that connects a top end of the first vertical section 452 to a bottom end of the second vertical section 453. Due to this configuration, the second vertical section 453 of the outer wall extends vertically and directly above the inner wall 450 so as to form an opening 462 fluidly connected to the internal region 456. The first vertical section 452 of the outer wall includes the distributor inlet 444 for injecting the second catalyst stream into the device 442. The base 454 of the device 442 includes at least one base opening (not shown) for receiving the second feed stream. The second feed stream flows into a lower section 466 of the device 442 to be vaporized upon contact with the second catalyst stream. The mixing of the second feed and second catalyst streams forms a second feed/catalyst mixture, hereafter referred to as “fluidized ring mixture 468”, within a cavity 470 of the device 442. The catalyst particles are fluidized by the vaporized feed so that the fluidized ring mixture 468 rises upwardly to flow through the opening 462 and into a wall region 464.

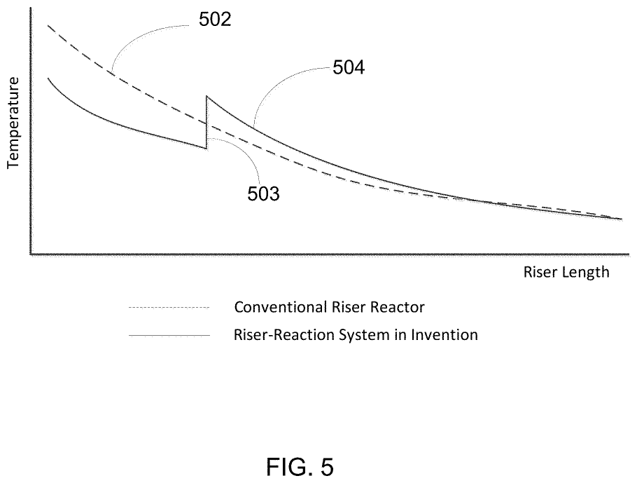

As it moves upwardly along the center vertical axis 458, a stream of hydrocarbons 436 can be described as including a core-annulus pattern where a concentration of densely aggregated catalyst particles (i.e., dense catalyst layer 472) flow downwardly within the wall region 464 while a concentration of less densely aggregated catalyst particles (i.e., central catalyst 474) continue to flow upwardly along the center vertical axis 458. The formation of the dense catalyst layer 472 within the wall region 464 often leads to non-uniform distribution of catalyst particles and non-uniform feed/catalyst mixing throughout the cracking zone 440, as well, as non-uniform gas/solid velocity distribution profiles. Moreover, the dense catalyst layer 472 flowing downwardly along the wall region 464, or the periphery of the cracking zone 440, can increase the chance for back-mixing of solid catalyst particles. The occurrence of back-mixing often results in incomplete cracking thereby decreasing product yields. However, in the present embodiments, the upward flow of the fluidized ring mixture 468 into the wall region 464 acts to deflect the downward flow of dense catalyst layer 472. Thus, by forcing the dense catalyst layer 472 back into the internal region 456, improved feed/catalyst contact and improved catalyst distribution is achieved, along with minimal to no back-mixing. With such improvements, the present embodiments thereby advantageously promote desirable plug-flow conditions since minimized catalyst back-mixing occurs, thereby, reducing undesirable cracking reactions so as to increase the yield of desired products. Moreover, ideal plug flow conditions reduce the occurrence of side and incomplete catalytic reactions and thus, also increases the yield of desired products. Additionally, due to desirable plug-flow conditions, the velocity flow rates through the inventive riser-reactor are assumed to be more constant and uniform, as compared to typical velocity profiles in conventional riser-reactors. Thus, the present riser-reactor embodiment also provides improved overall radial gas and solid velocity profiles, as measured along the length of the riser-reactor. FIG. 5 is a graphical comparison of a temperature profile for a conventional riser-reactor as compared to a temperature profile for the riser-reactor system with multi-stage catalyst injection as shown in FIG. 2, in accordance with the embodiments of the present invention. As shown in FIG. 5, temperatures, as measured by any desirable unit as known in the art, within a riser-reactor are plotted against the height of the riser-reactor, as measured in any desirable unit as known in the art. The temperature profile for both the conventional riser-reactor 502 (as depicted by a dashed line) and the temperature profile for the riser-reactor system with multi-stage catalyst injection 504 (as depicted by a solid line) of the present invention are both descending as the height of the riser-reactor increases due to the nature of endothermic cracking reactions. Accordingly, the temperature profiles, as described herein, are related to temperatures within the riser-reactor along a substantial majority of the length of the riser-reactor.

As discussed with respect to FIG. 2 and as shown by FIG. 5, the hydrocarbons stream within the evaporation zone of the present riser-reactor is subjected to temperatures that are at least 50° C. lower than the temperatures within a bottom section of the conventional riser-reactor. The evaporation zone in the present embodiments is located just below the first feed injection location of the riser-reactor up to about the 5 meters (m) above the first feed injection location. The advantages of using the inventive riser-reactor system with multi-stage catalyst injection translates to at least a 15% reduction, preferably a 20% reduction, and more preferably a 25% reduction, in the overall temperature profile as compared to the conventional riser-reactor. In this regard, the hydrocarbons stream within the evaporation zone of the present riser-reactor maintains lower temperatures as compared to the feed/catalyst mixture in the conventional riser-reactor until entering a cracking zone. In particular, after the injection of a second feed/catalyst mixture into the cracking zone, the first feed/catalyst mixture is subjected to elevated temperatures as cracking reactions begin, thus, forming a spike 503 in temperatures as shown by the temperature profile for the riser-reactor system with multi-stage catalyst injection 504.

Based on the findings depicted in FIG. 5, it has been surprisingly found that the inventive riser-reactor promotes improved temperature profiles along the entire length of the reactor since typical elevated temperatures (e.g., 630° C. and above) are avoided, especially within the evaporation zone. In accordance with the embodiments, the temperature in the evaporation zone is of a lower operating severity, i.e., less than 625° C., preferably less than 550° C. (as shown by FIG. 5), and most preferably less than 525° C., so as to advantageously reduce thermal cracking and catalytic cracking within the evaporation zone. Due to reduced thermal cracking in the evaporation zone, other beneficial effects such as a reduction dry gas production and increased FCC unit capacity can be exhibited, thus, leading to improved product distribution, i.e., desirable end products. It should be noted that the size, including riser-reactor length and diameter, of the inventive riser-reactor may vary depending on the operational parameters and level of desired hydrocarbon feed conversion and production capacity, among other variables.

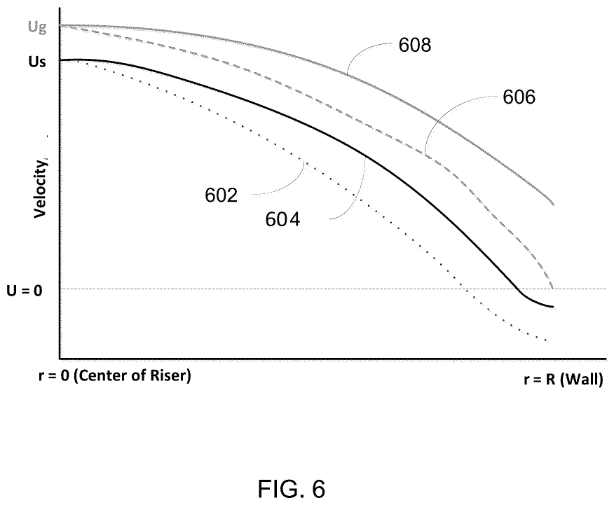

FIG. 6 is a graphical comparison of radial distribution profiles of axial velocities for a conventional riser-reactor as compared to radial distribution profiles of axial velocities for the riser-reactor system with multi-stage catalyst injection as shown in FIG. 2, in accordance with the embodiments of the present invention. As depicted in FIG. 6, velocity is plotted against the length of a riser-reactor. Specifically, the gas velocity (“U_{g}”) and the solid velocity (“Uₛ”), as measured in any desirable unit as known in the art, are plotted against a center region (“r=0”) of the riser-reactor to a wall region (“r=R”) of the riser-reactor, as measured in any desirable unit as known in the art. The solid (“s”) relates to a catalyst particle component and the gas (“g”) relates to a vaporized feed or product component, where both components are the constituents that form the hydrocarbon/catalyst mixtures flowing within the riser-reactor.

As previously described with respect to FIGS. 3 and 4, the inventive riser-reactor includes a second stage injection device for the injection of a second catalyst stream and a second feed stream into a cracking zone. The second catalyst and second feed mix together to form a second catalyst/feed mixture, which acts to further crack a partially cracked hydrocarbons streams flowing from an evaporation zone into the cracking zone. As illustrated by the gas and solid velocity profiles depicted in FIG. 6, the added benefits of implementing a second stage injection device in the inventive riser-reactor are readily apparent when compared with conventional riser-reactors that fail to incorporate second stage injection. As shown in FIG. 6, the solid velocity for catalyst particles in a conventional riser-reactor is depicted by dashed line 602 and the solid velocity for the inventive riser-reactor is depicted by solid line 604. The solid velocity of the inventive riser-reactor 604 is more uniform than the solid velocity of the conventional riser-reactor 602. In particular, the solid velocity of the inventive riser-reactor 604 at the wall region X (r=R) shows that the back-mixing of the catalyst in the wall region is significantly reduced.

Likewise, the gas velocity for vaporized feed in a conventional riser-reactor is depicted by dashed line 606 and the gas velocity for vaporized feed in the inventive riser-reactor is depicted by solid line 608. The gas velocity of the inventive riser-reactor 608 is more uniform than the gas velocity of the conventional riser-reactor 606. As depicted in FIG. 6, the gas vapors in the inventive riser-reactor 608 continue to maintain a significant velocity, even as the gas vapors in the conventional riser-reactor 606 approach the wall region. This means that the flow (for both catalyst and gas) in the inventive riser-reactor is more “plug-flow” resulting in higher conversion (i.e., higher yield), as well as, more desirable product distribution.

The objectives of the present invention included minimizing thermal cracking of a hydrocarbon feed and dry gas production during vaporization of the feed and improving feed/catalyst mixing and overall temperature and gas/solid velocity profiles during FCC processes. The inventive riser-reactor and methods of catalytically cracking a hydrocarbon feed using the inventive riser-reactor fulfill the objectives of the present invention. As described in the aforementioned embodiments, the inventive riser-reactor includes at least one evaporation zone where feed vaporization and feed-catalyst mixing are contained to at least one evaporation zone before passing into at least one cracking zone to be further cracked. The inventive riser-reactor limits temperatures in the evaporation zone to less than 625° C., preferably less than 550° C., more preferably less than 525° C., thereby, inhibiting thermal cracking reactions within the evaporation zone. Accordingly, a substantial majority, more preferably essentially all, cracking of the vaporized feed occurs in the cracking zone, and not the evaporation zone, of the present riser-reactor embodiments. With the reduction in thermal cracking during feed vaporization and feed/catalyst mixing, another advantage as provided by the inventive embodiments included an overall lower (also more uniform) temperature profile, as opposed to the temperature profile of conventional riser-reactors. Consequently, another surprising benefit provided by the present embodiments due to a lower temperature profile includes a reduction in dry gas production/coke deposit and increased FCC unit capacity for higher yields of desirable products.

Moreover, the enhancements provided by the inventive riser-reactor are strengthened by multi-stage catalyst injection. After a first stage catalyst injection into the evaporation zone, the techniques of the present embodiments can include a second stage catalyst injection into the cracking zone. By evenly distributing the catalyst concentration not just within the evaporation zone but along the entire length, the riser-reactor of the embodiments provides more complete and uniform feed/catalyst mixing along the entire length of the riser-reactor. In addition to improved catalyst distribution, the distribution of the vaporized feed is also improved since solid catalyst particles flowing in a wall region are pushed back into a center region of the riser-reactor. In this regard, the present embodiments provide more uniform, and thus, improved radial solid velocity profiles along the entire length of the inventive riser-reactor. The synergistic behavior provided by the improved gas and solid velocity profiles of the present embodiments promotes reduced back-mixing, improved solid/gas mixing, and ideal plug flow conditions, which in turn, enhances catalytic reactions so as to provide higher yields of desirable products.

While the present techniques may be susceptible to various modifications and alternative forms, the exemplary examples discussed above have been shown only by way of example. It is to be understood that the technique is not intended to be limited to the particular examples disclosed herein. Indeed, the present embodiments include all alternatives, modifications, and equivalents falling within the scope of the present techniques.

1. A process for fluid catalytic cracking (FCC) a hydrocarbon feed in a riser-reactor, the process comprising:
injecting the hydrocarbon feed into an evaporation zone of the riser-reactor;
injecting a first catalyst into the evaporation zone, wherein the first catalyst mixes with the hydrocarbon feed to generate a hydrocarbons stream in the evaporation zone, and wherein the temperature in the evaporation zone is less than 625° C.;
passing the hydrocarbons stream from the evaporation zone into a cracking zone of the riser-reactor to generate a cracked product in the cracking zone.

2. The process according to claim 1, further comprising:
adjusting the amount of first catalyst injected into the evaporation zone to minimize cracking of the hydrocarbons stream in the evaporation zone.

3. The process according to claim 1, wherein vaporization of the hydrocarbon feed and mixing of the hydrocarbon feed with the first catalyst occurs across an entire diameter of the riser-reactor and within the evaporation zone.

4. The process according to claim 1, further comprising:
injecting a second catalyst into a wall region located in the cracking zone to further crack the hydrocarbons stream, wherein the injection of the second catalyst minimizes catalyst back-mixing in the wall region and changes the radial velocity distribution of the cracked product in the cracking zone.

5. The process according to claim 4, further comprising:
adjusting a ratio of first catalyst to second catalyst injected into the riser-reactor to minimize cracking of the hydrocarbons stream in the evaporation zone and to maximize cracking of the hydrocarbons stream in the cracking zone.

6. A riser-reactor for fluid catalytic cracking (FCC) a hydrocarbon feed, comprising:
an evaporation zone comprising a first catalyst distributor to receive a first catalyst and a feed distributor to receive the hydrocarbon feed, wherein the first catalyst mixes with the hydrocarbon feed to generate a hydrocarbons stream mixture in the evaporation zone, wherein the temperature in the evaporation zone is less than 625° C.;
a cracking zone to receive the hydrocarbons stream mixture, wherein the hydrocarbons stream is cracked to produce a cracked product in the cracking zone; and
a separation zone to receive the cracked product from the cracking zone, wherein a spent catalyst is separated and removed from the cracked product in the separation zone.

7. The process according to claim 1, wherein the hydrocarbons stream that passes from the evaporation zone and into the cracking zone is partially cracked.

8. The riser-reactor according to claim 6, wherein the cracking zone comprises a second catalyst distributor located in a wall region of the cracking zone to receive a second catalyst, wherein minimal catalyst back-mixing occurs in the wall region of the riser-reactor and radial velocity distribution changes for the cracked product occur in the cracking zone.

9. The riser-reactor according to claim 6, wherein minimal cracking of the hydrocarbons stream occurs in the evaporation zone and wherein maximum cracking of the hydrocarbons stream occurs in the cracking zone.

10. The process according to claim 5, wherein a ratio of first catalyst to second catalyst in the riser reactor is about 1:9 to 9:1.

11. The process according to claim 4, wherein a ratio of total catalyst to hydrocarbon feed in the riser reactor is about 1:1 to 30:1.

12. The riser-reactor according to claim 6, wherein the evaporation zone extends across an entire diameter of the riser-reactor.
